(19) United States
(12) Patent Application Publication
(10) Pub. No.: US 2024/0256285 A1
(43) Pub. Date: Aug. 1, 2024

(54) PARALLELIZING MULTI-PHASE KERNELS WITH CROSS-PHASE DEPENDENCY ON HETEROGENOUS HARDWARE

(71) Applicant: Microsoft Technology Licensing, LLC, Redmond, WA (US)

(72) Inventors: Skand HURKAT, Bellevue, WA (US); Tiyasa MITRA, Saratoga, CA (US)

(21) Appl. No.: 18/103,796

(22) Filed: Jan. 31, 2023

(51) Int. Cl. G06F 9/38

(52) U.S. Cl. CPC G06F 9/38

(57) ABSTRACT

The methods and systems perform multi-phase algorithms on data tensors. The methods and systems overlap the phases of a multi-phase algorithm and process different phases of the multi-phase algorithm concurrently on independent segments of a data tensor using multiple heterogeneous hardware execution units. The methods and systems process an entire segment of the data tensor with a phase before moving on to a next phase for the segment.

### BACKGROUND

Neural networks involve operations such as normalization, softmax, etc. These operations have multiple phases. For example, the softmax operation must subtract the maximum value aggregated over a dimension of the input tensor before computing exponents to ensure good numerical stability and then sum the exponents and divide all the exponents by this computed sum. Another example includes the normalization operation that must compute the mean and standard deviation along some dimensions of the input tensor before subtracting the mean and dividing it by the standard deviation. In the above examples, the algorithm for performing the softmax operation or the normalization operation introduces a data dependency across these phases, one value (or values) must be computed before the algorithm can proceed to the next phase of computation.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes identifying a multi-phase algorithm to perform on a data tensor. The method includes providing, to a processor with multiple hardware execution units, instructions to simultaneously process different phases of the multi-phase algorithm on independent segments of the data tensor using the multiple hardware execution units of the processor.

Some implementations relate to a method. The method includes identifying a multi-phase algorithm to perform on a data tensor. The method includes creating a fused phase by combining a plurality of phases of the multi-phase algorithm together. The method includes providing, to a processor with multiple hardware execution units, instructions to simultaneously process the fused phase on independent segments of the data tensor using the multiple hardware execution units of the processor. The method includes continuing to provide, to the processor with multiple hardware execution units, instructions to process the fused phase on the independent segments of the data tensor until each phase of the multi-phase algorithm is processed in order on each segment of the data tensor.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example hardware with multiple heterogenous execution units in accordance with implementations of the present disclosure.

FIG. 2 illustrates an example of a data tensor with a plurality of segments in accordance with implementations of the present disclosure.

FIG. 3 illustrates an example of a data tensor with column blocks in accordance with implementations of the present disclosure.

FIG. 4 illustrates an example of fusing other processes or operations to phases of a multi-phase algorithm in accordance with implementations of the present disclosure.

FIG. 5 illustrates an example of data movement within a column of a tensor in accordance with implementations of the present disclosure.

FIG. 6 illustrates an example of performing a multi-phase algorithm in accordance with implementations of the present disclosure.

FIG. 7 illustrates an example method of executing a multi-phase algorithm on a data tensor in accordance with implementations of the present disclosure

FIG. 8 illustrates an example method of executing a multi-phase algorithm on a data tensor in accordance with implementations of the present disclosure.

### DETAILED DESCRIPTION

This disclosure generally relates to multi-phase algorithms with cross-phase data dependencies. Neural networks involve operations such as normalization, softmax, etc. These operations have multiple phases. For example, the softmax operation must subtract the maximum value aggregated over a dimension of the input tensor before computing exponents to ensure good numerical stability and then sum the exponents and divide all the exponents by this computed sum. Another example includes the normalization operation that must compute the mean and standard deviation along some dimensions of the input tensor before subtracting the mean and dividing it by the standard deviation. In the above examples, the algorithm for performing the softmax operation or the normalization operation introduces a data dependency across these phases that requires aggregation over values of the input data, one value (or values) must be computed, and results aggregated before the algorithm can proceed to the next phase of computation.

Computer processors (CPUs, GPUs, vector processors, etc.) typically have multiple functional units, each unit can process one or more operations (and only these operations). For example, some units may be dedicated to multiplying and adding numbers, while other units may be specialized in computing exponents of input values. Every unit implemented in hardware occupies some area. Typically, the hardware is sized for each phase of a multi-phase algorithms, or these multi-phase algorithms are implemented on a given hardware (e.g., processor) that can support the multi-phase algorithms. The multi-phase algorithms typically severely underutilize some of the hardware units in the hardware in phases that do not involve the operations provided by these hardware units. A computer designer is motivated to maximize the throughput in a given area. Therefore, it is advantageous to keep all the hardware units busy simultaneously to maximize the throughput of the algorithm and the area utilization.

The present disclosure provides methods and systems for parallelizing multi-phase algorithms with cross-phase data dependencies on hardware with multiple heterogeneous execution units. The methods and systems have an advantage of maximizing utilization of the heterogeneous execution units if the multiple phases of the multi-phase algorithm have different processing requirements.

A multi-phase algorithm is an operation with one or more phases where one phase must be completed on a subset of data and results aggregated before starting the next phase of operations on the same data set. A heterogenous processing unit is a processor with multiple hardware execution units, where each hardware execution unit can perform one or more specific operations (e.g., subtract, add, multiply, divide, exponentiation, load, store, inverse, square root, etc.) and multiple hardware execution units may be utilized at the same time.

Different phases of a multi-phase algorithm typically have different operations, and therefore, use different execution units of the hardware for performing the operations. One example includes the softmax operation, which has three phases: a first phase with a maximum; a second phase with subtraction, exponentiation, addition; and a third phase with division. Another example includes the normalization operation, which has two phases, a first phase with two additions and a multiplication, and a second phase with subtraction and division.

The methods and systems overlap the phases of a multi-phase algorithm and process different phases of the multi-phase algorithm at the same time on independent segments of a data tensor resulting in the mix of hardware units needed to process the multi-phase algorithm being more diverse than in any one phase by itself. The methods and systems have an advantage of maximizing utilization of the heterogenous execution units if the multiple phases of the operations have different processing requirements while maintaining the data dependency between the different phases of the multi-phase algorithms.

The methods and systems provide hardware information that identifies the multiple heterogeneous units of the hardware and the different functionality that the heterogeneous units offer (e.g., add, multiply, divide, exp, load, store, inverse, square root, etc.). The hardware may be any neural network hardware or any processors with multiple hardware units, where each hardware unit can perform one or more specific operations. In some implementations, the hardware is a special purpose processing device to perform a certain function or group of functions. In some implementations, the hardware is a computer processor. In some implementations, the hardware is a custom processor that is not commercially available.

The software code fuses (combines) adjacent phases of the multi-phase algorithms together so that the hardware processes the operations for adjacent phases together at the same time on different segments of the data tensors. One example includes the software code combines the first phase and the second phase of a multi-phase algorithm together so that the hardware performs the operations for the first phase and the second phase concurrently on different chunks or segments of the data tensor. Another example includes the software code combines the first phase, the second phase, and the third phase of a multi-phase algorithm together so that the hardware performs the operations of the first phase, the second phase, and the third phase concurrently on different chunks or segments of the tensor data. Another example includes the software code combines the second phase, the third phase, and a fourth phase together so that the hardware performs the operations of the second phase, the third phase, and the fourth phase concurrently on different chunks or segments of the tensor data.

The methods and systems perform the multi-phase algorithms on large data tensors with a true data dependency across elements in each dimension of the tensors. In some implementation, the tensors include a plurality of columns of data, which represents the different segments of the tensor. The data dependency exists within each column of data. The data dependencies do not exist across other dimensions of the tensor.

The methods and systems process an entire segment of the tensor with a phase before moving on to a next phase for the segment, and thus, maintains the data dependency among the different phases. By fusing the phases that have an aggregate data dependency across multiple phases of the multi-phase algorithm together into a pipeline fashion, the performance of the multi-phased operation is improved by using multiple execution units to perform the different operations of the phases.

One technical advantage of the methods and systems of the present disclosure is maximizing utilization of heterogeneous execution units in hardware. The methods and systems improve the utilization of the execution units by using a combined kernel. A combined or fused kernel includes operations from multiple phases in the innermost iteration of a loop, so that any heterogenous hardware executing that kernel sees an instruction stream from multiple phases. Another technical advantage of the methods and systems of the present disclosure is improving utilization of execution units, resulting in a reduction in an amount of hardware area needed to achieve a given throughput, or conversely, better throughput for a given hardware area. Another technical advantage of the methods and systems of the present disclosure is a reduction in the time required for processing the multi-phase algorithm. The methods and systems maximize the utilization of hardware (e.g., processors) with multiple heterogenous units that may perform different types of operations (e.g., add, multiply, divide, exp, load, store, inverse, square root, etc.) while maintaining the true data dependency between the phases.

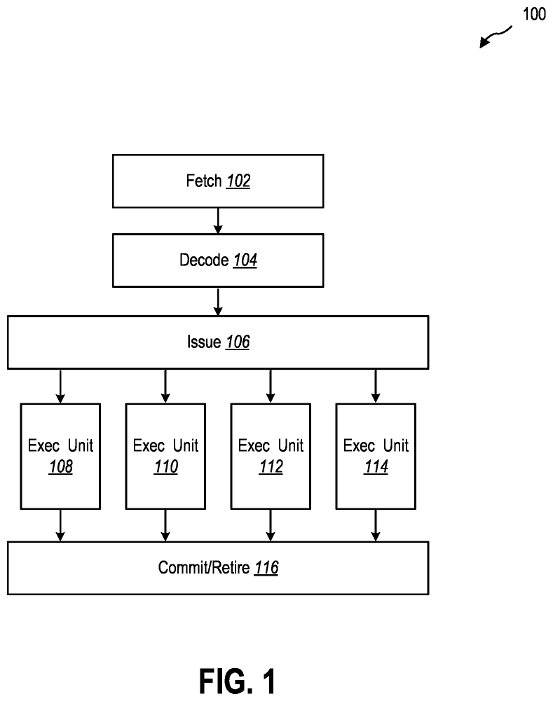

Referring now to FIG. 1, illustrated is example hardware 100 with multiple heterogenous execution units 108, 110, 112, 114 for use with multi-phase algorithms. A multi-phase algorithm is an operation with one or more phases where one phase must be completed on a subset of data and results aggregated before starting the next phase of operations on the same data set. One example of a multi-phase algorithm is a normalization operation. Another example of a multi-phase algorithm is a softmax operation. In some implementations, machine learning models use the hardware 100 to perform the multi-phase algorithms on data tensors. In some implementations, the hardware 100 is a processor. For example, the processor is a traditional computer processor. Another example includes the processor is a vector processor. Another example includes the processor is a single-instruction multiple data (SIMD) processor. Another example includes the processor is a single-instruction multiple threads (SIMT) processor.

The hardware 100 includes a plurality of execution units 108, 110, 112, 114 where each execution unit 108, 110, 112, 114 may perform one or more operations (e.g., subtraction, add, multiply, divide, exp, load, store, inverse, square root, etc.) and multiple execution units 108, 110, 112, 114 may be utilized at the same time. Examples of the execution units 108, 110, 112, 114 include FMA (fused multiply-accumulate) execution units, as well as ALUs (arithmetic logic units) that can execute multiple operations (but only one operation at a time). In some implementations, each of the execution units 108, 110, 112, 114 perform different operations. For example, the execution unit 108 performs subtraction, the execution unit 110 performs a load, the execution unit 112 performs an inverse, and the execution unit 114 performs the square root. In some implementations, a portion of the execution units 108, 110, 112, 114 perform the same operations while the remaining execution units 108, 110, 112, 114 perform different operations. For example, the execution unit 108 performs addition, the execution unit 110 performs addition, the execution unit 112 performs subtraction, and the execution unit 114 performs multiplication. In some implementations, the execution units 108 and 110 perform multiplication, addition, or subtraction, the execution unit 112 performs inverse, sqrt, exp, log, and the execution unit 114 performs the divide operation. In some implementations, a portion of the execution units 108, 110, 112, 114 performs a set of operations (e.g., the execution units 108, 110 perform multiplication, division, addition, or subtraction) while a different portion of the execution units 108, 110, 112, 114 performs a different set of operations (e.g., the execution units 112, 114 perform inverse, square root, exp, or log).

The hardware 100 may perform a fetch 102 operation and obtain instructions to process a data tensor and decodes 104 the instructions for processing. In some implementations, the instructions are for processing the multi-phase algorithm on the data tensor. The hardware 100 performs an issue 106 that forwards the instruction to the execution units 108, 110, 112, 114 for performing the different operations for the different phases of the multi-phase algorithm. The execution units 108, 110, 112, 114 perform the specified operations of the different phases of the multi-phase algorithm.

In some implementations, hardware information is generated for the hardware 100 that identifies the multiple heterogeneous execution units 108, 110, 112, 114 of the hardware 100 and the different operations performed by the execution units 108, 110, 112, 114. In some implementations, the hardware information is provided to users to notify the users of the execution units 108, 110, 112, 114 in the hardware 100 and the operations performed by the different execution units 108, 110, 112, 114. One example user is a software developer that is developing software code to perform a multi-phase algorithm with different operations. The user may use the hardware information to write the software code for the multi-phase algorithm in such a way to provide instructions to strategically combine different phases of the multi-phase algorithm together in a pipeline to execute at the same time on different segments of the tensor. For example, the software code combines different phases of the multi-phase algorithms into a loop within the software code to provide instructions to the hardware 100 to process the phases included in the loop concurrently using the execution units 108, 110, 112, 114. The issue 106 operation of the hardware 100 may be performed in response to the instructions provided in the software code for the multi-phase algorithms.

In some implementations, the issue 106 provides instructions for processing different segments of the data tensor concurrently with different phases of the multi-phase algorithm. The execution units 108, 110, 112, 114 process either one element of the segment of the input data tensor or multiple elements of the segment of the input data tensor depending on the type of execution model of the hardware 100 (e.g., a single-instruction single-data (SISD) or single-instruction multiple data (SIMD)). The entire segment of the data tensor is processed with a phase of the multi-phase algorithm before executing a next phase of the multi-phase algorithm on the segment of the data tensor until all phases of the multi-phase algorithm are completed (processed on each segment of the data tensor). By combining the phases of the multi-phase algorithm in a pipeline to execute concurrently on different segments of the data tensor, diversity of operations performed by the execution units 108, 110, 112, 114 is achieved while maintaining the data dependency of the phases of the multi-phase algorithm. In addition, the performance of the multi-phase algorithm on the data tensor is improved by reducing execution time of the multi-phase algorithm.

The execution units 108, 110, 112, 114 may operate at the same time, and thus, the hardware 100 may perform different operations for different phases of the multi-phase algorithm at the same time using different execution units 108, 110, 112, 114. In some implementations, the hardware 100 uses one execution unit 108, 110, 112, 114 to perform operations for a single phase of the multi-phase algorithm. For example, the execution unit 112 performs a subtraction operation for the first phase of the multi-phase algorithm, the execution unit 108 performs an inverse operation for the second phase of the multi-phase algorithm, and the execution unit 114 performs an addition operation for the third phase of the multi-phase algorithm.

In some implementations, the hardware 100 uses a plurality of execution units 108, 110, 112, 114 to perform operations for a single phase of the multi-phase algorithm. For example, if the first phase of the multi-phase algorithm includes both addition and a multiplication and the second phase of the multi-phase algorithm includes subtraction and division, the hardware 100 uses the execution unit 108 to perform the addition operation for the first phase and the execution unit 110 to perform the multiplication operation for the first phase, and the hardware 100 uses the execution unit 112 to perform the subtraction operation for the second phase and the execution unit 114 to perform the division operation for the second phase.

In some implementation, the hardware 100 reuses the execution units 108, 110, 112, 114 to perform operations for the combined phases of the multi-phase algorithm, or even a single phase of the multi-phase algorithm. For example, a first phase of the multi-phase algorithm includes four addition operations and the execution units 108, 110 perform addition, hardware 100 executes the first phase instructions on the execution units 108, 110 twice over.

Another example includes a first phase of the multi-phase algorithm requires two addition operations and an inverse operation and a second phase of the multi-phase algorithm requires an addition operation and three multiplication operation. The hardware 100 provides three execution units (e.g., the execution units 108, 110, 112, 114) that perform an addition operation or a multiplication operation, and one execution unit (e.g., the execution units 108, 110, 112, 114) that perform an inverse operation. The hardware 100 reuses the different execution units (e.g., the execution units 108, 110, 112, 114) that perform the addition or multiplication operation for the different addition operations and multiplication operations for the first phase and the second phase.

Another example includes a first phase of the multi-phase algorithm requires a comparison operation, a second phase of the multi-phase algorithm requires a subtraction operation, a multiplication operation, and an exponentiation operation, and a third phase of the multi-phase algorithm requires a multiplication operation. The hardware 100 provides three execution units (e.g., the execution units 108, 110, 112, 114) that perform addition, multiplication, or subtraction operations, one execution unit (e.g., the execution units 108, 110, 112, 114) that performs a comparison operation, and one execution unit (e.g., the execution units 108, 110, 112, 114) that performs an exponentiation operation. The hardware 100 reuses the execution units that perform the addition, multiplication, or subtraction operation for the different subtraction and multiplication operations for the second phase and the third phase.

The hardware 100 performs a commit/retire 116 of the instruction in memory after the execution units 108, 110, 112, 114 have performed the processing on the data. While four execution units 108, 110, 112, 114 are illustrated in the hardware 100, it should be appreciated that any number of execution units may be added to the hardware 100. The hardware 100 is superscalar and can keep multiple execution units 108, 110, 112, 114 busy at the same time by issuing instructions to more than one execution unit 108, 110, 112, 114.

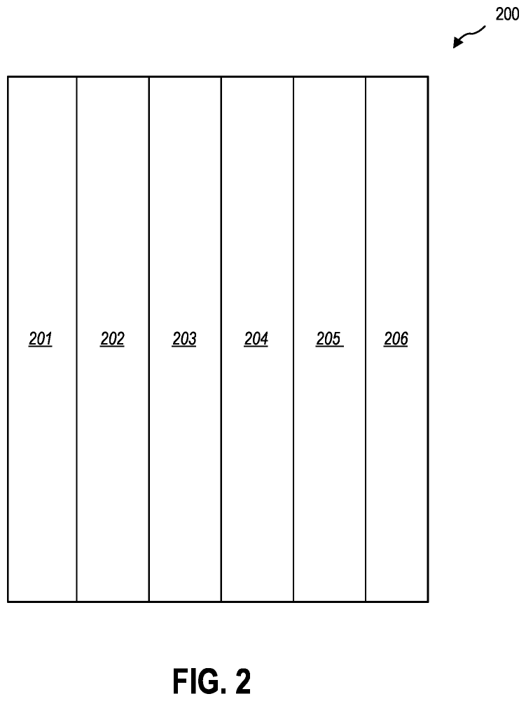

Referring now to FIG. 2, illustrated is an example of a data tensor 200 with a plurality of dimensions for use with the hardware 100 (FIG. 1). The data tensor 200 of data is a n-dimensional (where n is a positive integer greater than or equal to two) product of a vector space that may represent all types of data. The dimensions of the data tensor 200 without a data dependency are represented by a plurality of columns c (where c is a positive integer greater than or equal to two) (e.g., columns 201, 202, 203, 204, 205, 206). While two dimensions are illustrated in the data tensor 200 with six columns, it should be appreciated that the data tensor 200 may have any number of dimensions n (where n is a positive integer greater than or equal to two), and any depth d (where d is a positive integer greater than or equal to two) on each data independent dimension. The depth along different dimensions need not be equal.

A true data dependency exists across elements in a given dimension of the data tensor 200 (across elements within a given column 201, 202, 203, 204, 205, 206 of the data tensor 200). One example use case for normalization includes the elements within a given column 201, 202, 203, 204, 205, 206 and their squares must be summed within a single column 201, 202, 203, 204, 205, 206 to compute the mean and variance of the data before subtracting the mean and dividing by the square root of the variance. While the data tensor 200 illustrates the aggregate data dependency in a column (e.g., the entire column 201 must be processed with a first phase of the multi-phase algorithm before a second phase of the multi-phase algorithm can start of column 201), such a dependency may exist across any one dimension of the tensor, not necessarily only along columns.

Such data dependencies do not exist across other dimensions of the data tensor 200 (e.g., across other columns 201, 202, 203, 204, 205, 206 of the data tensor 200). As such, multiple segments (columns 201, 202, 203, 204, 205, 206) may be processed independent of each other. For example, all elements within the column 201 must be processed in a first phase of a multi-phase algorithm before the second phase of the multi-phase algorithm can begin on the same elements in the column 201. However, all columns 201, 202, 203, 204, 205, 206 may be processed in parallel.

One example use case includes a multi-phase algorithm with two phases. The hardware 100 (FIG. 1) receives the instructions to execute the first phase of the multi-phase algorithm on the first column 201 of the data tensor 200. The hardware 100 uses one or more of the execution units 108, 110, 112, 114 to perform the operation(s) of the first phase of the multi-phase algorithm on the data elements within the first column 201. When the first phase is complete on the first column 201 (all of the data elements within the first column 201 have been processed for the first phase by the execution unit 108), the hardware 100 receives instructions to execute the second phase of the multi-phase algorithm on the first column 201. The hardware 100 uses one or more of the execution units 108, 110, 112, 114 to perform the operation(s) of the second phase of the multi-phase algorithm on the data elements within the first column 201. At the same time as the second phase is being processing on the first column 201, the hardware 100 receives instructions to execute the first phase of the multi-phase algorithm on the second column 202 of data. The hardware 100 uses one or more of the execution units 108, 110, 112, 114 to perform the operation(s) of the first phase of the multi-phase algorithm on the data elements within the second column 202. When the second phase is complete on the first column 201, the hardware 100 receives instructions to execute the second phase of the multi-phase algorithm on the second column 202. The hardware 100 uses one or more of the execution units 108, 110, 112, 114 to perform the operation(s) of the second phase of the multi-phase algorithm on the data elements within the second column 202. At the same time as the second phase is being processed on the second column 202, the hardware 100 receives instructions to begin processing the first phase of the multi-phase algorithm on the third column 203. The hardware 100 uses one or more of the execution units 108, 110, 112, 114 to perform the operation(s) of the first phase of the multi-phase algorithm on the data elements within the third column 203.

If the multi-phase algorithm includes a third phase, upon completion of the second phase on the first column 201 and the first phase on the second column 202, a fused loop is created and instructions are provided to the hardware 100 to execute the fused loop where the third phase is executed on the first column 201, the second phase is executed on the second column 202, and first phase is executed on the third column 203 of data. The hardware 100 uses the execution units 108, 110, 112, 114 to perform the operations of the first phase, the second phase, and the third phase on the data elements within the first column 201, the second column 202, and the third column 203.

The software code for the multi-phase algorithm creates a software pipeline of the fused phases of the multi-phase algorithm and sends instructions to the hardware 100 for executing the fused loops within the software code. The fused loop fuses operations from more than one phase of the multi-phase algorithm, on elements from multiple columns. The fused loops causes the operations of a phase of the multi-phase algorithm to occur at the same time as an operation of an adjacent phase of the multi-phase algorithm. For example, the execution units 108, 110, 112, 114 performs the operations for the first phase of the multi-phase algorithm at the same time as the execution units 108, 110, 112, 114 perform the operations for the second phase of the multi-phase algorithm and the execution units 108, 110, 112, 114 performs the operations for the third phase of the multi-phase algorithm. Upon completion of the operations for each phase in the fused phase on a segment of data (e.g., a column 203, 204, 205), the hardware 100 starts executing operations for each phase in the fused phase on subsequent segments of data (e.g., columns 203, 204, 205), until the phases are executed on all of the columns 201, 202, 203, 204, 205, 206 of data. In some implementations, the hardware 100 runs fused loops of phases 2 through N−1 (N being the total number of phases in the multi-phase algorithm), then a fused loop of phases 3 through N−1, until completion of all phases in the multi-phase algorithm, and all data has been processed (all data elements within all columns 201, 202, 203, 204, 205, 206). By running fused loops of phases through the different segments of the data tensor 200, the hardware 100 is able to keep more execution units 108, 110, 112, 114 (FIG. 1) busy simultaneously.

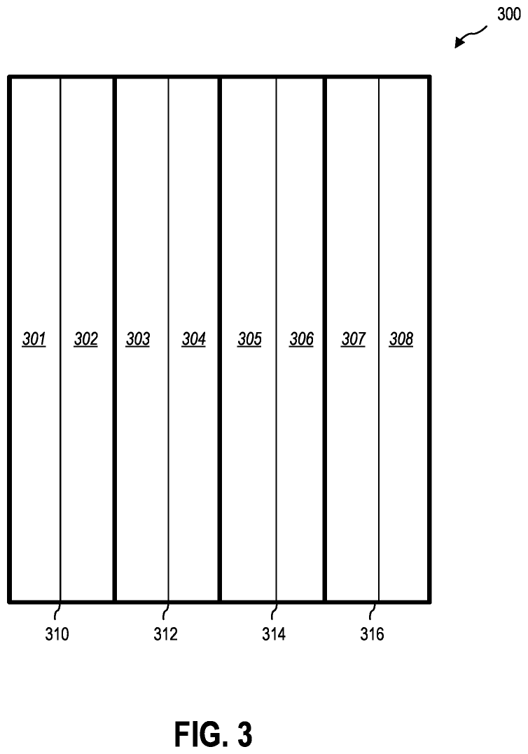

Referring now to FIG. 3, illustrated is an example of a data tensor 300 with column blocks 310, 312, 314, 316 for use with the hardware 100 (FIG. 1) based on the execution paradigm of the hardware for performing the multi-phase algorithm. In some implementations, the hardware 100 performs a single-instruction multiple-data (SIMD) paradigm. In some implementations, the hardware 100 is a graphics processing unit (GPU). Instead of the hardware 100 operating a phase of the multi-phase algorithm on an individual column of the data tensor 300 (e.g., an individual segment of the data tensor), the hardware processes a phase of the multi-phase algorithm on the column blocks 310, 312, 314, 316 of the data tensor 300 (e.g., a plurality of segments of the data tensor). The hardware 100 may execute fused phases of the multi-phase algorithm across the column blocks 310, 312, 314, 316.

The data tensor 300 includes a plurality of columns 301, 302, 303, 304, 305, 306, 307, 308. Multiple columns 301, 302, 303, 304, 305, 306, 307, 308 may be assigned into a single column block (e.g., column blocks 310, 312, 314, 316). For example, columns 301 and 302 are assigned to column block 310; columns 303 and 304 are assigned to column block 312; columns 305 and 306 are assigned to column block 314; and columns 307 and 308 are assigned to column block 316. In some implementations, the width of the column blocks 310, 312, 314, 316 (e.g., the number of columns included in the column block) is based on the hardware capabilities. For example, if the hardware 100 is capable of processing 128 elements of data in a single instruction, the width of the column blocks 310, 312, 314, 316 is 128 or the width of the column blocks 310, 312, 314, 316 is set to a multiple or a factor (e.g., 256 or 64).

The hardware 100 executes fused phases of the multi-phase algorithm across the column blocks 310, 312, 314, 316. An advantage of processing a phase of the multi-phase algorithm on the column blocks 310, 312, 314, 316 is the hardware 100 operates on more data with a single instruction.

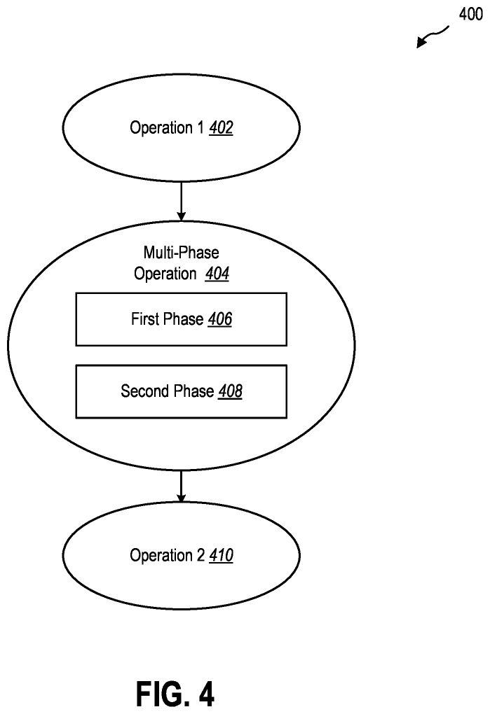

Referring now to FIG. 4, illustrated is an example of fusing other processes or operations to phases of a multi-phase algorithm. Illustrated is a flow chart 400 illustrating a first operation 402 that is performed prior to a multi-phase algorithm 404 that includes a first phase 406 and a second phase 408. The second operation 410 is performed after completion of the multi-phase algorithm 404.

The first operation 402 is adjacent to the first phase 46 of the multi-phase algorithm 404 and the second operation 410 is adjacent to the second phase 408 of the multi-phase algorithm 404. In some implementations, the first operation 402 is fused to the first phase 406 of the multi-phase algorithm 404. In some implementations, the second operation 410 is fused to the second phase 408 of the multi-phase algorithm. The hardware 100 may execute the first operation 402 and operations for the first phase 46 together on the data tensor and then start executing the operations for the second phase 408 and the second operation 410 on the data tensor. By fusing operations that proceed and/or succeed the multi-phase algorithm, with the first and/or last phase of the multi-phase algorithm, data movement is minimized. Thus, instead of the hardware 100 reading all of the data, processing the data, and writing the processed data back to memory for each of the first operation 402, the multi-phase algorithm 404, and the second operation 410, the hardware 100 reads the data once, processes the data for the first operation 402, the multi-phase algorithm 404, and the second operation 410 and writes the processed data back to memory. In some implementations, a data write occurs between the first phase 406 and the second phase 408 of the multi-phase algorithm 404.

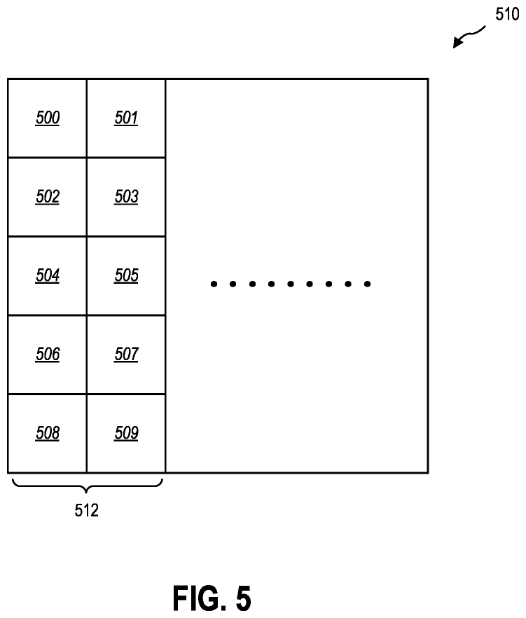

Referring now to FIG. 5, illustrated is an example of data movement within a column 512 of a data tensor 510. The column 512 includes data blocks 500, 501, 502, 503, 504, 505, 506, 507, 508, 509. As the tensor size increases, the data within a single column 512 of the data tensor 510 may not fit in on-chip memory. In some implementations, a cache or software managed scratchpad is available for on-chip memory. Software code may be written by the users to provide instructions for performing the multi-phase algorithm on the data blocks 500, 501, 502, 503, 504, 505, 506, 507, 508, 509 and to manage the data movement within the data blocks 500, 501, 502, 503, 504, 505, 506, 507, 508, 509 for use with the on-chip memory.

One example use case includes four of the data blocks 500, 501, 502, 503, 504, 505, 506, 507, 508, 509 fit in the on-chip cache or scratchpad memory and the multi-phase algorithm includes two phases. The software code may provide instructions that that the following operations are conducted by the hardware 100 (FIG. 1) in parallel for the two phase multi-phase algorithm. The first operation writes out intermediate results, if any, to off-chip memory from processing the data blocks 500, 501, and re-use the same space to read in the data blocks 504, 505 to the on-chip memory. The second operation computes the first phase of the multi-phase algorithm on the memory block 503 and the second phase of the multi-phase algorithm on the memory block 502. The software code switches to writing out intermediate results from the data blocks 502, 503 to off-chip memory (e.g., DRAM), reading in the data blocks 506, 507, and processing the first phase of the multi-phase algorithm on the data blocks 505, the second phase of the multi-phase algorithm on the memory block 504.

The software code continues providing instructions for the filling (reading in the data blocks 500, 501, 502, 503, 504, 505, 506, 507, 508, 509 to the on-chip memory), computing (performing the different phases of the multi-phase algorithm on the data blocks 500, 501, 502, 503, 504, 505, 506, 507, 508, 509), and draining (writing out the intermediate results from the data blocks 500, 501, 502, 503, 504, 505, 506, 507, 508, 509 to the off-chip memory) to pipeline the data movement of the data blocks 500, 501, 502, 503, 504, 505, 506, 507, 508, 509 on the on-chip memory for processing the different phases of the multi-phase algorithm.

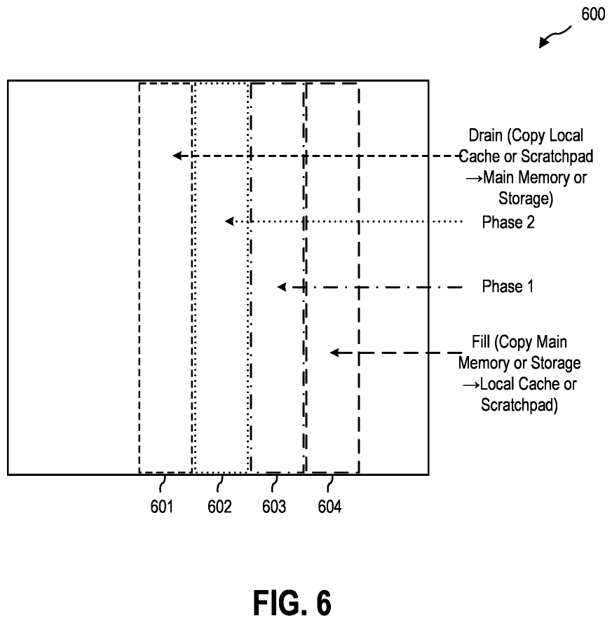

Referring now to FIG. 6, illustrated is an example of performing a layer normalization multi-phase algorithm across the columns 601, 602, 603, 604 of a data tensor 600 using optimized pseudocode for the layer normalization multi-phase algorithm. The layer normalization includes two phases.

An example of a typical unoptimized pseudocode for the layer normalization is illustrated below:

```
for (0 <= col_iter <num_col_blocks){
sum_x = 0
sum_x2 = 0
//Loop 1 over rows
for (0<= row_iter < num_rows){
  x = load(in_addr + row_iter)
  sum_x += x
  sum_x2 +=(x*x)
}
mean = sum_x/num_rows
var = (sum_x2/num_rows) − (mean*mean)
std_inv = 1/sqrt(var)
//Loop 2 over rows
for (0<= row_iter < num_rows){
  x = load (in_addr + row_iter)
  diff = x − mean
  gamma = load (gamma_addr + row_iter)
  beta = load (beta_addr + row_iter)
  res = (diff*std_inv*gamma) +beta
store (res, res_addr + row_iter)
}
}
```

Typically, a compiler maps the unoptimized kernel to assembly code, the complier identifies that the operations in loop 2 depend on the output of loop 1. Hence the complier will not merge the two loops together and unroll across both loops efficiently. The compiler is unable to comprehend that the compiler could instead compute loop2 for col_iter=n in parallel with loop 1 for col_iter=(n−1), thereby leading to more efficient use of available compute units.

An example of optimized pseudocode for the layer normalization multi-phase algorithm is illustrated below:

```
//warm-up: Loop1 for first iteration
{
sum_x = 0
sum_x2 = 0
for (0<= row_iter < num_rows){
  x = load (phase1_base + in_addr + row_iter)
  sum_x += x
  sum_x2 +=(x*x)
}
mean = sum_x/num_rows
var = (sum_x2/num_rows) − (mean*mean)
std_inv = 1/sqrt(var)
}
//Steady State: Loop1 and loop 2 of consecutive samples merged
for (0 < col_iter <num_col_blocks){
  //update phase base address pointers (assumes 2 scratch buffers
used iteratively)
  temp = phase2_base
phase2_base = phase1_base
phase1_base = temp
for (0 <= row_iter < num_rows){
  //Loop 1 ops for column block [col_iter]
  x1 = load (phase1_base + in_addr + row_iter)
  sum_x += x1
  sum_x2 +=(x1*x1)
  //Loop 2 ops for column block [col_ter − 1]
  x2 = load (phase2_base + in_addr + row_iter)
  diff = x2 − mean
  gamma = load (phase2_base + gamma_addr + row_iter)
  beta = load (phase2_base + beta_addr + row_iter)
  res = (diff*std_inv*gamma) +beta
store (res, phade2_base + res_addr + row_iter)
}
mean = sum_x/num_rows
var = (sum_x2/num_rows) − (mean*mean)
std_inv = 1/sqrt(var)
}
//Cool-down: phase 2 for last iteration
{
  phase2_base =phase1_base
for (0 <= row_iter < num_rows){
x2 = load (phase2_base + in_addr + row_iter)
  diff = x2 − mean
  gamma = load (phase2_base + gamma_addr + row_iter)
  beta = load (phase2_base + beta_addr + row_iter)
  res = (diff*std_inv*gamma) +beta
store (res, phade2_base + res_addr + row_iter)
}
}
```

In the above, optimized pseudocode for the layer normalization multi-phase algorithm, loop1 and loop2 are merged for consecutive samples together (see steady state section). By merging loop1 and loop2 together for consecutive samples, the compiler is able to reorder instructions across the two loops for maximum hardware utilization. Further, the compiler is also able to unroll the merged steady state loop easily, allowing for even more effective hardware optimizations and minimized loop overhead across multiple samples. For example, the optimized pseudocode provides instructions to the compiler for the hardware 100 for executing the operations of the first phase of the layer normalization operation on the column 603 and at the same time send instructions to the hardware 100 for executing the second phase of the layer normalization operation on the column 602.

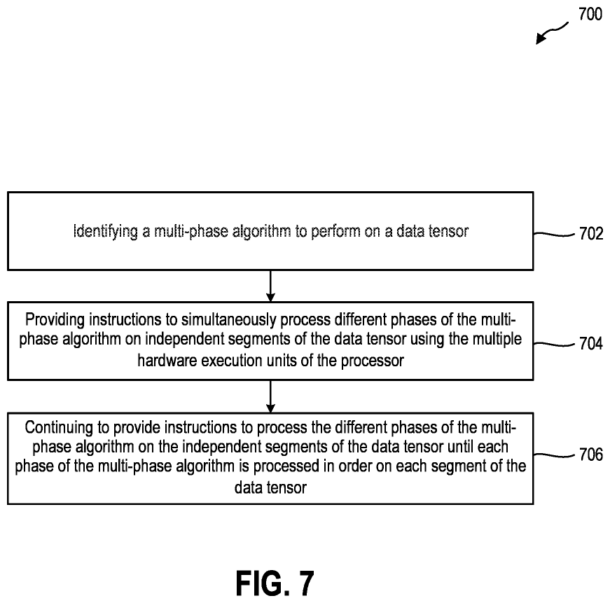

Referring now to FIG. 7, illustrated is an example method 700 for executing a multi-phase algorithm on a data tensor. The actions of the method 700 are discussed below with reference to FIGS. 1-6. In some implementations, the actions of the method 700 are discussed with reference to a processor (e.g., the hardware 100) with multiple hardware execution units (e.g., the execution units 108, 110, 112, 114). In some implementations, the processor (e.g., the hardware 100) includes heterogeneous execution units 108, 110, 112, 114 that perform different types of operations (e.g., add, multiply, divide, exp, load, store, inverse, square root, etc.) where multiple execution units 108, 110, 112, 114 may be utilized at the same time.

In some implementations, each of the execution units 108, 110, 112, 114 perform different operations. For example, the execution unit 108 performs subtraction, the execution unit 110 performs a load, the execution unit 112 performs an inverse, and the execution unit 114 performs the square root. In some implementations, a portion of the execution units 108, 110, 112, 114 perform the same operations while the remaining execution units 108, 110, 112, 114 perform different operations. For example, the execution unit 108 performs addition, the execution unit 110 performs addition, the execution unit 112 performs subtraction, and the execution unit 114 performs multiplication. In some implementations, a portion of the execution units 108, 110, 112, 114 performs a set of operations (e.g., the execution units 108, 110 perform multiplication, division, addition, or subtraction) while a different portion of the execution units 108, 110, 112, 114 performs a different set of operations (e.g., the execution units 112, 114 perform inverse, square root, exp, or log).

At 702, the method 700 includes identifying a multi-phase algorithm to perform on a data tensor. A multi-phase algorithm (e.g., the multi-phase algorithm 404) is an operation with one or more phases (e.g., the first phase 406 and the second phase 408) where one phase must be completed on a subset of data and results aggregated before starting the next phase of operations on the same data set. One example of a multi-phase algorithm is a normalization operation. Another example of a multi-phase algorithm is a softmax operation. The multi-phase algorithm includes a data dependency between phases of the multi-phase algorithm that requires processing of the data within an entire segment of the data tensor for each phase of the multi-phase algorithm before moving to a next phase of the multi-phase algorithm.

In some implementations, machine learning models use the hardware 100 to perform the multi-phase algorithms on data tensors (e.g., the data tensor 200, the data tensor 300, the data tensor 510, the data tensor 600). The data tensor (e.g., the data tensor 200, the data tensor 300, the data tensor 510, the data tensor 600) is a n-dimensional (where n is a positive integer greater than or equal to two) product of a vector space that may represent all types of data. The dimensions of the data tensor without a data dependency may be represented by a plurality of columns (e.g., the columns 201, 202, 203, 204, 205, 206, the columns 301, 302, 303, 304, 305, 306, 307, 308, the column 512, the columns 601, 602, 603, 604). It should be appreciated that the data tensor may have any number of dimensions n (where n is a positive integer greater than or equal to two), and any depth d (where d is a positive integer greater than or equal to two) on each data independent dimension. The depth along different dimensions need not be equal.

At 706, the method 700 includes providing, to a processor with multiple hardware execution units, instructions to simultaneously process different phases of the multi-phase algorithm on independent segments of the data tensor using the multiple hardware execution units of the processor. A dependency exists among data elements within a segment of the data tensor.

In some implementations, software code for the multi-phase algorithm provides instructions to the processor (e.g., the hardware 100) to process different operations of different phases of the multi-phase algorithm on independent segments (e.g., 201, 202, 203, 204, 205, 206, the columns 301, 302, 303, 304, 305, 306, 307, 308, the column 512, the columns 601, 602, 603, 604) of the data tensor (e.g., the data tensor 200, the data tensor 300, the data tensor 510, the data tensor 600 using multiple hardware execution units 108, 110, 112, 114 in the hardware 100. The software code combines the phases of the multi-phase algorithm in a pipeline to execute at the same time on different segments of the tensor. For example, the software code combines different phases of the multi-phase algorithms into a loop within the software code to provide instructions to the hardware 100 to process the phases included in the loop at the same time.

In some implementations, the hardware 100 uses multiple execution units 108, 110, 112, 114 to perform different operations of a phase of the multi-phase algorithm. The hardware 100 performs the operations of the phase on an entire segment of the tensor before executing the operations of a next phase of the multi-phase algorithm on the segment. In some implementations, the hardware 100 uses the same execution units 108, 110, 112, 114 to perform the operations of the next phase of the multi-phase algorithm. In some implementations, the hardware 100 uses different execution units 108, 110, 112, 114 to perform the operations of the next phase of the multi-phase algorithm. In some implementations, the hardware 100 uses a combination of the same and different execution units 108, 110, 112, 114 to perform the operations of the next phase of the multi-phase algorithm. The hardware 100 continues to perform the operations of the next phases of the multi-phase algorithm until all phases of the multi-phase algorithm are completed (processed on each segment of the tensor).

The software code for the multi-phase algorithm provides instructions to the hardware 100 to concurrently execute different phases of the multi-phase algorithm. In some implementations, the hardware 100 uses one execution unit of the execution unit 108, 110, 112, 114 to perform an operation of the multi-phase algorithm. For example, the execution unit 112 performs an addition required by the first phase of the multi-phase algorithm, the execution unit 108 performs a multiplication required by the first phase of the multi-phase algorithm, and the execution unit 114 performs an inverse required by the first phase of the multi-phase algorithm.

In some implementations, the hardware 100 uses a subset of the execution units to execute operations for a phase of the multi-phase algorithm, where the subset of the execution units includes two or more execution units. For example, if the first phase of the multi-phase algorithm includes both addition and a multiplication and the second phase of the multi-phase algorithm includes subtraction and division, the hardware 100 uses the execution unit 108 to perform the addition for the first phase and the execution unit 110 to perform the multiplication for the first phase, and the hardware 100 uses the execution unit 112 to perform the subtraction for the second phase and the execution unit 114 to perform the division for the second phase.

The execution units 108, 110, 112, 114 may operate at the same time, and thus, the hardware 100 may perform the operations for different phases of the multi-phase algorithm at the same time using different execution units 108, 110, 112, 114. By combining the phases of the multi-phase algorithm in a pipeline to execute concurrently on different segments of the tensor, diversity of operations performed by the execution units 108, 110, 112, 114 is achieved while maintaining the data dependency of the phases of the multi-phase algorithm. In addition, the performance of the multi-phase algorithm on the tensor is improved by reducing execution time of the multi-phase algorithm.

At 708, the method 700 includes continuing to provide instructions to process the different phases of the multi-phase algorithm on the independent segments of the data tensor until each phase of the multi-phase algorithm is processed in order on each segment of the data tensor. The software code continues to provide instructions to the hardware 100 to perform operations for the different phases of the multi-phase algorithm using the execution units 108, 110, 112, 114 on independent segments of the data tensor until each phase of the multi-phase algorithm is processed in order on each segment of the data tensor. The execution units 108, 110, 112, 114 perform the operations for the phase on the entire segment of the tensor before executing the operations for a next phase of the multi-phase algorithm on the segment until all phases of the multi-phase algorithm are completed (processed on each segment of the tensor).

In some implementations, a fused phase is generated by combining a plurality of phases of the multi-phase algorithm together and the fused phase is provided to the hardware 100 so that execution units 108, 110, 112, 114 concurrently process operations for the fused phase on independent segments of the data tensor until the fused phase is processed on each segment of the data tensor. For example, the software code for the multi-phase algorithm combines a plurality of the phases (e.g., combines two phases together or combines three phases together) of the multi-phase algorithm together within one loop of the software code to ensure that the plurality of the phases of the multi-phase algorithm are concurrently processed by the hardware 100 using the execution units 108, 110, 112, 114 of the hardware 100 to perform the operations of the plurality of phases on independent segments of the data tensor. By running fused phases through the different segments of the data tensor, the hardware 100 is able to keep more execution units 108, 110, 112, 114 busy simultaneously.

In some implementations, a fused phase is generated by combining all of phases of the multi-phase algorithm together and the fused phase is provided to the hardware 100 so that the execution units 108, 110, 112, 114 concurrently process operations for the fused phase on independent segments of the data tensor until the fused phase is processed on each segment of the data tensor. For example, the software code for the multi-phase algorithm combines all of the phases of the multi-phase algorithm together within one loop of the software code to provide instructions so that the operations of all of the phases of the multi-phase algorithm are concurrently performed by the execution units 108, 110, 112, 114 of the hardware 100 on independent segments of the data tensor.

In some implementations, column blocks (e.g., the column blocks 310, 312, 314, 316) are generated for the data tensor (e.g., the data tensor 300) by combining a plurality of segments (e.g., the columns 301, 302, 303, 304, 305, 306, 307, 308) of the data tensor (e.g., the data tensor 300) together. The software code provides instructions to the hardware 100 to concurrently process different phases of the multi-phase algorithm on independent column blocks (e.g., the column blocks 310, 312, 314, 316) of the data tensor (e.g., the data tensor 300). In some implementations, the width of the column blocks 310, 312, 314, 316 (e.g., the number of columns included in the column block) is based on the hardware capabilities. For example, if the hardware 100 is capable of processing 128 elements of data in a single instruction, the width of the column blocks 310, 312, 314, 316 may be set to 128 or the width of the column blocks 310, 312, 314, 316 may be set to a multiple or a factor (e.g., 256 or 64).

In some implementations, an operation (e.g., the first operation 402) that occurs prior to the multi-phase algorithm (e.g., the multi-phase algorithm 404) is identified. The software code generates a fused phase by combining the operation (e.g., the first operation 402) to a first phase (e.g., the first phase 406) of the multi-phase algorithm (e.g., the multi-phase algorithm 404) within a loop of the software code. The software code provides instructions to process the fused phase concurrently using the execution units 108, 110, 112, 114 on independent segments of the data tensor until the fused phase is processed on each segment of the data tensor.

In some implementations, an operation (e.g., the second operation 410) that occurs after the multi-phase algorithm (e.g., the multi-phase algorithm 404) is identified. The software code generates a fused phase by combining the operation (e.g., the second operation 410) to a last phase (e.g., the second phase 408) of the multi-phase algorithm (e.g., the multi-phase algorithm 404) within a loop of the software code. The software code provides instructions to process the fused phase concurrently using the execution units 108, 110, 112, 114 on independent segments of the data tensor until the fused phase is processed on each segment of the data tensor.

In some implementations, the data blocks (e.g., the data blocks 500, 501, 502, 503, 504, 505, 506, 507, 508, 509) within a segment (e.g., the column 515) of the data tensor (e.g., the data tensor 510) are identified and a size of on-chip memory is determined for the hardware 100. The size is equal to a number of data blocks that fit in the on-chip memory. The software code may provide instructions to fill the on-chip memory with the number of data blocks for the size and process a first phase of the multi-phase algorithm on a first portion of the data blocks. The software code may provide instruction that upon completion of the first phase, writing out the first portion of the data blocks to off-chip memory and filling in a third portion of the data blocks to the on-chip memory. The software code may also provide instructions for processing a second phase of the multi-phase algorithm on a second portion of the data blocks and upon completion of the second phase of the multi-phase algorithm, writing out the second portion of the data blocks to off-chip memory and filling a fourth portion of the data blocks to the on-chip memory. The software code may provide instructions to continue to process any remaining data blocks in the segment of the data tensor using the on-chip memory and moving the processed data blocks to off-chip memory until each of the data blocks are processed in the segment.

The method 700 overlaps the phases of multi-phase algorithms while maintaining a true data dependency between the phases of the multi-phase algorithm. The method 700 uses different execution units 108, 110, 112, 114 in the hardware 100 to perform different phases of the multi-phase algorithms at the same time, and thus, improving the performance of the multi-phase algorithm by reducing the processing time needed to complete the multi-phase algorithm. The method 700 also improves the performance of the multi-phase algorithm by reducing an amount of area on the hardware 100 needed for processing the multi-phase algorithm.

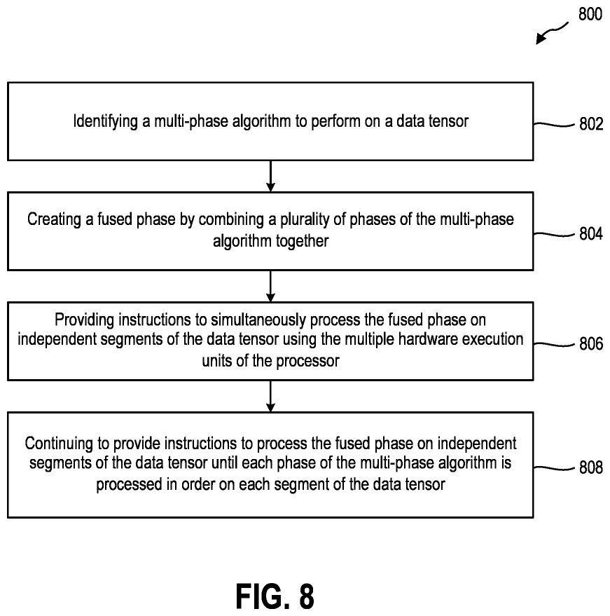

Referring now to FIG. 8, illustrated is an example method 800 for performing a multi-phase algorithm on a data tensor. The actions of the method 800 are discussed below with reference to FIGS. 1-6.

At 802, the method 800 includes identifying a multi-phase algorithm to perform on a data tensor. A multi-phase algorithm (e.g., the multi-phase algorithm 404) is an operation with one or more phases (e.g., the first phase 406 and the second phase 408) where one phase must be completed on a subset of data and results aggregated before starting the next phase of operations on the same data set. One example of a multi-phase algorithm is a normalization operation. Another example of a multi-phase algorithm is a softmax operation. The multi-phase algorithm includes a data dependency between phases of the multi-phase algorithm that requires processing of the data within an entire segment of the data tensor for each phase of the multi-phase algorithm before moving to a next phase of the multi-phase algorithm.

The data tensor (e.g., the data tensor 200, the data tensor 300, the data tensor 510, the data tensor 600) is a n-dimensional product (where n is a positive integer greater than or equal to two) of a vector space that may represent all types of data. The dimensions of the data tensor without a data dependency may be represented by a plurality of columns (e.g., the columns 201, 202, 203, 204, 205, 206, the columns 301, 302, 303, 304, 305, 306, 307, 308, the column 512, the columns 601, 602, 603, 604). It should be appreciated that the data tensor may have any number of dimensions n (where n is a positive integer greater than or equal to two), and any depth d (where d is a positive integer greater than or equal to two) on each data independent dimension. The depth along different dimensions need not be equal.

At 804, the method 800 includes creating a fused phase by combining a plurality of phases of the multi-phase algorithm together into the fused phase. For example, the software code for the multi-phase algorithm combines a plurality of phases of the multi-phase algorithm together within one loop of the software code to ensure that the operations of the plurality of phases are concurrently processed by the multiple hardware execution units 108, 110, 112, 114 of the hardware 100 on independents segments of the data tensor (e.g., different columns of the data tensor).

In some implementations, the fused phase includes each phase of the multi-phase algorithm. One example use case includes the multi-phase algorithm has six phases. The software code for the multi-phase algorithm combines the six phases together within one loop of the software code to ensure that the operations of the six phases are concurrently processed by the multiple hardware execution units 108, 110, 112, 114 of the hardware 100 on independent segments of the data tensor (e.g., different columns of the data tensor).

Another example use case includes the multi-phase algorithm has two phases and the fused phase includes the first phase and the second phase. The software code for the multi-phase algorithm combines the first phase and the second phase together of the multi-phase algorithm together within one loop of the software code to ensure that the operations of the first phase and the second phase are concurrently processed by the multiple hardware execution units 108, 110, 112, 114 of the hardware 100 on independent segments of the data tensor (e.g., different columns of the data tensor).

Another example use case includes the multi-phase algorithm has three phases and the fused phase includes the first phase, the second phase, and the third phase. The software code for the multi-phase algorithm combines the first phase, the second phase, and the third phase together within one loop of the software code to ensure that the operations of the first phase, the second phase, and the third phase are concurrently processed by the multiple hardware execution units 108, 110, 112, 114 of the hardware 100 on independent segments of the data tensor (e.g., different columns of the data tensor).

In some implementations, the fused phase includes a subset of phases of the multi-phase algorithm. For example, if the multi-phase algorithm includes four phases, the fused phase may include the first phase, the second phase, and the third phase. The software code for the multi-phase algorithm combines the first phase, the second phase, and the third phase together within one loop of the software code to ensure that the operations of the first phase, the second phase, and the third phase are concurrently processed by the multiple hardware execution units 108, 110, 112, 114 of the hardware 100 on independent segments of the data tensor (e.g., different columns of the data tensor).

In some implementations, a plurality of fused phases include different subsets of phases of the multi-phase algorithm. For example, if the multi-phase algorithm includes five phases, a first fused phase may include a subset of two phases and a second fused phase may include a subset of three phases. The software code for the multi-phase algorithm combines the first phase and the second phase together within one loop of the software code to create the first fused phase to ensure that the operations of the first phase and the second phase are concurrently processed by the multiple hardware execution units 108, 110, 112, 114 of the hardware 100 on independent segments of the data tensor (e.g., different columns of the data tensor) and combines the third phase, the fourth phase, and the fifth phase together within another loop of the software code to create the second fused phase to ensure that the operations of the third phase, the fourth phase, and the fifth phase are concurrently processed by the multiple hardware execution units 108, 110, 112, 114 of the hardware 100 on independent segments of the data tensor.

At 806, the method 800 includes providing, to a processor with multiple hardware execution units, instructions to simultaneously process the fused phase on independent segments of the data tensor using the multiple hardware execution units of the processor. The software code for the multi-phase algorithm provides instructions to the hardware 100 to process the fused phase on independent segments (e.g., the columns 201, 202, 203, 204, 205, 206, the columns 301, 302, 303, 304, 305, 306, 307, 308, the column 512, the columns 601, 602, 603, 604) of the data tensor (e.g., the data tensor 200, the data tensor 300, the data tensor 510, the data tensor 600).

The hardware 100 uses the multiple hardware execution units 108, 110, 112, 114 to perform the operations of the fused phase of the multi-phase algorithm on the data elements in the independent segments of the data tensor. By performing the operations of the fused phases on the different segments (e.g., the columns 201, 202, 203, 204, 205, 206, the columns 301, 302, 303, 304, 305, 306, 307, 308, the column 512, the columns 601, 602, 603, 604) of the data tensor (e.g., the data tensor 200, the data tensor 300, the data tensor 510, the data tensor 600), the hardware 100 is able to keep more execution units 108, 110, 112, 114 busy simultaneously.

At 808, the method 800 includes continuing to provide, to the processor with multiple hardware execution units, instructions to process the fused phase on independent segments of the data tensor until each phase of the multi-phase algorithm is processed in order on each segment of the data tensor. The software code continues to provide instructions to the hardware 100 to perform operations for the fused phase of the multi-phase algorithm using the execution units 108, 110, 112, 114 on independent segments of the data tensor until the fused phase is processed in order on each segment of the data tensor. The execution units 108, 110, 112, 114 perform the operations for the fused phase on the entire segment of the tensor before executing the operations for the fused phase on a next segment of the data tensor until the fused phase is processed on each segment of the tensor. By running fused phases through the different segments of the data tensor, the hardware 100 is able to keep more execution units 108, 110, 112, 114 busy simultaneously.

By fusing the phases that have an aggregate data dependency across multiple phases of the multi-phase algorithm together into a pipeline fashion, the method 800 averages the hardware requirements of the different phases, which means that a processor already able to issue instructions to the multiple execution units simultaneously can now find enough variety in the instructions to issue them to the multiple execution units, improving efficiency of the hardware.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a binary model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The features and functionalities discussed herein in connection with the various systems may be implemented on one computing device or across multiple computing devices. The features and functionalities discussed herein in connection with the various systems may be implemented wholly on the same computing device. In addition, one or more subcomponents of the features and functionalities discussed herein may be implemented across multiple computing devices. Moreover, in some implementations, the one or more subcomponents of the features and functionalities discussed herein are implemented or processed on different server devices of the same or different cloud computing networks. Moreover, in some implementations, the features and functionalities are implemented or processed on different server devices of the same or different cloud computing networks.

In some implementations, the features and functionalities discussed herein include hardware, software, or both. For example, the features and functionalities may include one or more instructions stored on a computer-readable storage medium and executable by processors of one or more computing devices. When executed by the one or more processors, the computer-executable instructions of one or more computing devices can perform one or more methods described herein. In some implementations, the features and functionalities include hardware, such as a special purpose processing device to perform a certain function or group of functions. In some implementations, the features and functionalities include a combination of computer-executable instructions and hardware.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
identifying a multi-phase algorithm to perform on a data tensor; and
providing, to a processor with multiple hardware execution units, instructions to simultaneously process different phases of the multi-phase algorithm on independent segments of the data tensor using the multiple hardware execution units of the processor.

2. The method of claim 1, wherein each execution unit of the multiple hardware execution units handles a subset of an instruction set of the processor.

3. The method of claim 1, further comprising:
continuing to provide instructions to process the different phases of the multi-phase algorithm on the independent segments of the data tensor until each phase of the multi-phase algorithm is processed in order on each segment of the data tensor.

4. The method of claim 1, wherein the hardware includes heterogeneous execution units where each execution unit performs an operation.

5. The method of claim 1, wherein a subset of the execution units are used to perform operations for a phase of the multi-phase algorithm, wherein the subset of the execution units includes two or more execution units.

6. The method of claim 1, wherein a same subset of execution units are used to perform operations for multiple phases of the multi-phase algorithm.

7. The method of claim 1, wherein the multi-phase algorithm includes a data dependency between phases of the multi-phase algorithm that requires processing of the data within an entire segment of the data tensor for each phase of the multi-phase algorithm before moving to a next phase of the multi-phase algorithm for the segment.

8. The method of claim 1, wherein a data dependency exists among data elements within a segment of the data tensor.

9. The method of claim 1, further comprising:
generating a fused phase by combining a plurality of phases of the multi-phase algorithm together; and
providing instructions to concurrently process the fused phase on the independent segments of the data tensor using the multiple hardware execution units until the fused phase is processed on each segment of the data tensor.

10. The method of claim 1, further comprising:
generating a fused phase by combining all of phases of the multi-phase algorithm together; and
providing instructions to concurrently process the fused phase on the independent segments of the data tensor using the multiple hardware execution units until the fused phase is processed on each segment of the data tensor.

11. The method of claim 1, further comprising:
generating column blocks of the data tensor by combining a plurality of segments of the data tensor together; and
providing instructions to concurrently process different phases of the multi-phase algorithm on independent column blocks of the data tensor.

12. The method of claim 1, further comprising:
identifying an operation that occurs prior to the multi-phase algorithm;
generating a fused phase by combining the operation to a first phase of the multi-phase algorithm; and
providing instructions to concurrently process the fused phase on the independent segments of the data tensor until the fused phase is processed on each segment of the data tensor.

13. The method of claim 1, further comprising:
identifying an operation that occurs after the multi-phase algorithm;
generating a fused phase by combining the operation to a last phase of the multi-phase algorithm; and
providing instructions to concurrently process the fused phase on the independent segments of the data tensor until the fused phase is processed on each segment of the data tensor.

14. The method of claim 1, further comprising:
identifying data blocks within a segment of the data tensor;
determining a size of on-chip memory for the hardware, wherein the size is equal to a number of data blocks that fit in the on-chip memory;
providing instructions to fill the on-chip memory with the number of data blocks for the size;
providing instructions to process a first phase of the multi-phase algorithm on a first portion of the data blocks;
upon completion of the first phase, providing instructions to write out the first portion of the data blocks to off-chip memory and fill in a third portion of the data blocks to the on-chip memory;
providing instructions to process a second phase of the multi-phase algorithm on a second portion of the data blocks;
upon completion of the second phase of the multi-phase algorithm, providing instructions to write out the second portion of the data blocks to the off-chip memory and filling a fourth portion of the data blocks to the on-chip memory; and
providing instructions to continue to process any remaining data blocks in the segment of the data tensor using the on-chip memory and move the processed data blocks to the off-chip memory until each of the data blocks are processed in the segment.

15. A method, comprising:
identifying a multi-phase algorithm to perform on a data tensor;
creating a fused phase by combining a plurality of phases of the multi-phase algorithm together;
providing, to a processor with multiple hardware execution units, instructions to simultaneously process the fused phase on independent segments of the data tensor using the multiple hardware execution units of the processor; and
continuing to provide, to the processor with multiple hardware execution units, instructions to process the fused phase on the independent segments of the data tensor until each phase of the multi-phase algorithm is processed in order on each segment of the data tensor.

16. The method of claim 15, wherein the fused phase includes each phase of the multi-phase algorithm.

17. The method of claim 15, wherein the fused phase includes a subset of phases of the multi-phase algorithm.

18. The method of claim 17, wherein a plurality of fused phases include different subsets of phases of the multi-phase algorithm.

19. The method of claim 15, wherein columns of the data tensor represent different segments of data in the data tensor.

20. The method of claim 15, wherein the multiple hardware execution units execute operations of the fused phase.
